(19) United States
(12) Patent Application Publication
(10) Pub. No.: US 2023/0278311 A1
(43) Pub. Date: Sep. 7, 2023

(54) COMPONENT FOR HOME APPLIANCE AND METHOD OF MANUFACTURING HOME APPLIANCE

(71) Applicant: LG ELECTRONICS INC., Seoul (KR)

(72) Inventors: Youngdae YOU, Seoul (KR); Seong Un KIM, Seoul (KR); Joonbeom KIM, Seoul (KR)

(21) Appl. No.: 18/118,242

(22) Filed: Mar. 7, 2023

(30) Foreign Application Priority Data
Mar. 7, 2022 (KR) 10-2022-0029006

(51) Int. Cl. B32B 3/28; B32B 3/30; B32B 27/08; B32B 27/20

(52) U.S. Cl. CPC B32B 3/28; B32B 3/30; B32B 27/08; B32B 27/20; B32B 2509/10; B32B 2307/4026; B32B 2264/105; B32B 2272/00; B32B 2250/02; B32B 2250/24; B29C 45/16

(57) ABSTRACT

A component for a home appliance made of a plate having various shapes, the component having a cross-section including a skin layer made of a first material by injection-molding; and a core layer disposed on the skin layer and made of a second material, which is different from the first material, by injection-molding. The cross-section may have a curved area and a straight area, and a thickness of the curved area may be greater than a thickness of the straight area.

### CROSS-REFERENCE TO RELATED APPLICATION(S)

This application claims priority to and the benefit of Korean Patent Application No. 10-2022-0029006, filed in Korea on Mar. 7, 2022, the disclosure of which is incorporated herein by reference in its entirety.

### BACKGROUND

### 1. Field

A component for a home appliance and a method of manufacturing a component for a home appliance are disclosed herein.

### 2. Background

Double injection molding is a method of giving special functions to plastic products along with visual effects by molding different types of materials in one piece. As components for a home appliance, a core material uses recycled resin or pulverized material to reduce unit cost, and a skin material is a metallic material that enhances the appearance or gives functions, such as antibacterial or anti-fingerprint.

In the double injection molding, a core is fabricated with a first injection molding machine and a mold. Then, the core is inserted into a second injection molding machine and a mold. Thereafter, a skin is molded to produce a finished product, which is called insert injection molding.

In the case of the insert injection molding, deformation and shrinkage occur due to a temperature difference on a surface of the core generated by the high-temperature skin during the second injection molding. In addition, cracks occur in the core due to pressure during the second injection molding or adhesiveness decreases at an interface between the core and the skin. The insert injection molding has a high possibility of the above-noted defects, so that the need for new injection molding technology developments is on the rise.

### BRIEF DESCRIPTION OF THE DRAWINGS

Embodiments will be described in detail with reference to the following drawings in which like reference numerals refer to like elements, and wherein:

FIG. 1 is a perspective view of a home appliance according to an embodiment;

FIG. 2 is a perspective view of a component for a home appliance according to an embodiment;

FIG. 3 is a side view and a partial cross-sectional view of a component for a home appliance according to an embodiment; and

FIG. 4 a-f shows methods of manufacturing the component for the home appliance according to an embodiment.

### DETAILED DESCRIPTION

Aspects, features, and advantages are specifically described hereinafter with reference to the accompanying drawings such that one having ordinary skill in the art to which embodiments pertain may easily implement the technical spirit. Hereinafter, detailed descriptions of known technologies are omitted if they are deemed to make the gist unnecessarily vague. Hereinafter, embodiments are specifically described with reference to the accompanying drawings. In the drawings, identical reference numerals can denote identical or similar components.

The terms “first”, “second” and the like are used herein only to distinguish one component from another component. Thus, the components should not be limited by the terms. Certainly, a first component can be a second component unless stated to the contrary.

Throughout, each component can be provided as a single one or a plurality of ones, unless explicitly stated to the contrary.

Hereinafter, expressions of ‘a component is provided or disposed in an upper or lower portion’ may mean that the component is provided or disposed in contact with an upper surface or a lower surface. The present disclosure is not intended to limit that other elements are provided between the components and on the component or beneath the component.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Throughout, the terms “A and/or B” as used herein can denote A, B or A and B, and the terms “C to D” can denote C or greater and D or less, unless stated to the contrary.

Hereinafter, referring to the accompanying drawings, a component for a home appliance and a method of manufacturing a component for a home appliance according to embodiments will be described. A home appliance, to which a component for a home appliance (hereinafter, a “home appliance component”) according to embodiments may be applied, may be a refrigerator, a washing machine, a dryer, or an oven, for example. In this embodiment, a refrigerator is described as one example.

The component may include various components used in home appliances, and in particular, the component may be a thin plate forming an exterior design of the home appliance. In this embodiment, the home appliance component may be applied to a dispenser panel of a refrigerator as one example.

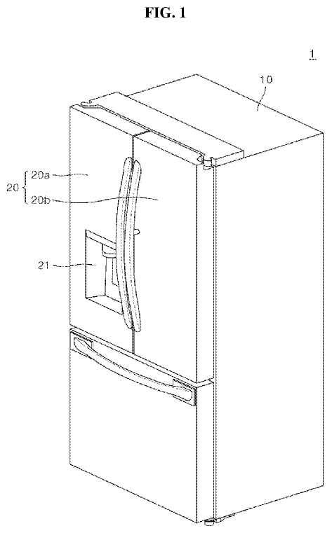

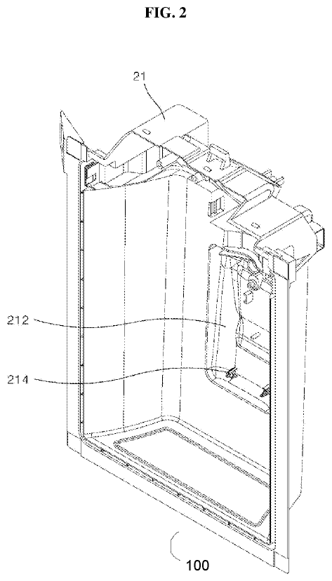

FIG. 1 is a perspective view of a home appliance according to an embodiment. FIG. 2 is a perspective view of a component for a home appliance according to an embodiment.

Home appliance 1 according to an embodiment may include a case 10 defining a storage chamber and a door 20 rotatably coupled to the case 10 to open and close the storage chamber. The door 20 may include a left or first door 20a, a right or second door 20a and a dispenser panel 21 defining an exterior design of a dispenser module 100 disposed in the left door 20a and configured to dispense, for example, drinking water or ice.

The dispenser panel 21 may be formed by injection as a thin plate, and may be formed in various shapes. The dispenser panel 21 may include a recessed portion 212 horizontally recessed in an upright bowl shape, and a rib 214 that protrudes from a flat area of the recessed portion 212.

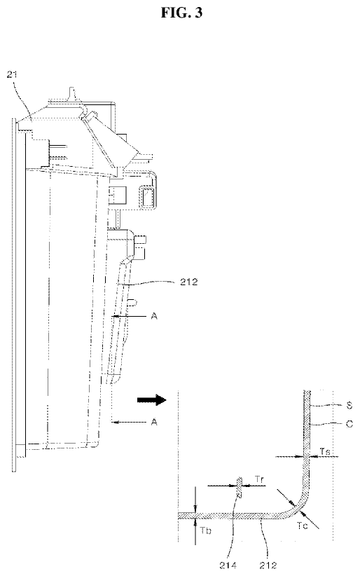

FIG. 3 is a side view and a partial cross-sectional view of a component for a home appliance according to an embodiment. The dispenser panel 21 provided as the home appliance component according to an embodiment may include a skin layer S having a cross-sectional area formed of a first material by injection-molding, and a core layer C disposed on the skin layer S and formed of a second material different from the first material.

In this embodiment, the first material constituting the skin layer S may be a metallic resin and the second material constituting the core layer C may be recycled resin. The skin layer S may be a resin having a metallic color, that is, a resin containing a metal material to provide continuity of color with a metal, which is a material of the refrigerator door 20.

The dispenser panel 21 may be fabricated by double-injection molding which is a method for manufacturing the core layer C and the skin layer S simultaneously. When using this manufacturing method, a thickness of a cross-section needs to be adjusted based on a shape so as not to expose the core layer C to the outside.

With respect to the cross-section in a vertical direction, that is, A-A, of the recessed portion 212, as shown in FIG. 3, a thickness Tc of a curved area or portion in the cross-section may be greater than thicknesses Ts, Tb of straight areas or portions. The thickness Ts of a vertical area or portion may be greater than the thickness Tb of a horizontal area or portion. The thickness of the plate Tc, Ts, Tb may be greater than a thickness Tr of the rib 214. In other words, the thickness based on the shape may be as follows:

Tc>Ts>Tb>Tr

The thickness of each part may not be constant and a minimum thickness of a thicker area is compared with a maximum thickness of a less thick area. In other words, the minimum thickness Tc of the curved area is greater than the maximum thickness Ts, Tb of the straight area. The minimum thickness Ts of the vertical area is greater than the maximum thickness of the horizontal area. The minimum thickness Tc, Ts, Tb of the plate is greater than the maximum thickness of the rib 214.

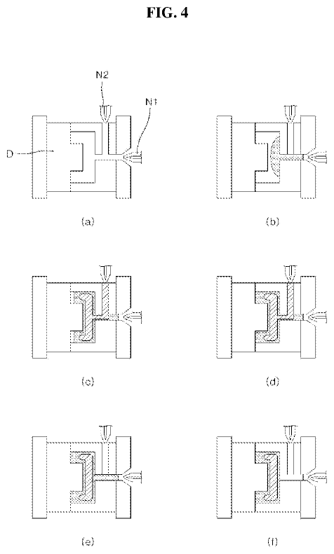

FIG. 4 shows a method of manufacturing the component for the home appliance according to an embodiment. The dispenser panel 21 which is the home appliance component according to this embodiment may be manufactured using a manufacturing machine including one mold D and two nozzles N1 and N2.

The method of manufacturing the home appliance component may include injecting a first material forming skin layer S into the mold (b); injecting a second material different from the first material and forming core layer C (c); stopping the injection of the second material (e); and stopping the injection of the first material (f).

For double-injection of the dispenser panel 21 shown in (a) of FIG. 4, one mold D and two nozzles N1, N2 may be prepared. First nozzle N1 may inject the first material forming the skin layer S into the mold D. Second nozzle N2 may inject the second material forming the core layer C into the mold D.

As shown in (b) FIG. 4, the first nozzle N1 may inject the first material forming the skin layer S into the mold D when a preset or predetermined amount of the first material is injected, and the second nozzle N2 may inject the second material forming the core layer C into the mold D, as shown in (c) of FIG. 4. At this time, the first nozzle N1 is continuously injecting the first material, so that the first material and the second material may be injected into the mold D simultaneously.

Once the core layer C is completely formed by completing the injection of the preset amount of the second material, as shown in (d) of FIG. 4, the second nozzle N2 may stop the injection of the second material as shown in (e) of FIG. 4. At this time, the first nozzle N1 may continuously inject the first material. Once the skin layer S is completely formed by completing the injection of the preset amount of the first material, the first nozzle N1 may stop the injection of the first material, as shown in (f) of FIG. 4.

Based on the above-described method, the dispenser panel 21 constituting the skin layer S and the core layer C may be manufactured.

Embodiments disclosed herein provide a component for a home appliance with an improved injection process, and a method of manufacturing a component for a home appliance.

Advantages are not limited to the above advantages, and other advantages not mentioned above may be clearly understood from the following description and may be more clearly understood from the embodiments set forth herein.

Embodiments disclosed herein provide a component for a home appliance made of a plate having various shapes formed therein, the component having in cross-section a skin layer made of a first material by injection-molding; and a core layer disposed on the skin layer and made of a second material, which is different from the first material, by injection-molding. The cross-section may have a curved area and a straight area and a thickness of the curved area may be greater than a thickness of the straight area. The cross-section may have a vertical area and a horizontal area and a thickness of the vertical area may be greater than a thickness of the horizontal area.

The cross-section may include a plate area and a rib that protrudes from the plate area. A thickness of the plate area may be greater than a thickness of the rib.

The skin layer and the core layer may be formed by injecting the first material into a mold, injecting the second material into the mold, stopping the injection of the second material, and then stopping the injection of the first material.

Embodiments disclosed herein further provide a method of manufacturing a component for a home appliance having a plate shape and a cross-section including a skin layer and a core layer disposed on the skin layer. The method according to an embodiment may include injecting a first material forming the skin layer into a mold; injecting a second material forming the core layer and different from the first material; stopping the injection of the second material; and stopping the injection of the first material.

A component for a home appliance according to embodiments disclosed herein has at least one or more of the following advantages.

First, the component for the home appliance according to embodiments disclosed herein may be manufactured based on double-injection with one mold. Accordingly, there is an advantageous effect of reducing manufacturing costs.

Second, recycled resin may be used to form an exterior of the component for the home appliance. Accordingly, there is another advantageous effect of reducing costs and protecting the environment.

Finally, the home appliance has a further advantage of double-injecting the relatively large plate-shaped component.

Specific advantages are described along with the above-described advantages in the Detailed Description.

Embodiments are described above with reference to a number of illustrative embodiments thereof. However, embodiments are not intended to limit the embodiments and drawings set forth herein, and numerous other modifications and embodiments can be devised by one skilled in the art. Further, the effects and predictable effects based on the configurations herein are to be included within the range of the disclosure though not explicitly described in the description of the embodiments.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A component for a home appliance made of a plate, the component having a cross-section comprising;
a skin layer made of a first material by injection-molding; and
a core layer disposed on the skin layer and made of a second material, which is different from the first material, by injection-molding, wherein the cross-section has a curved area and a straight area, and wherein a thickness of the curved area is greater than a thickness of the straight area.

2. The component for the home appliance of claim 1, wherein the cross-section has a vertical area and a horizontal area, and wherein a thickness of the vertical area is greater than a thickness of the horizontal area.

3. The component for the home appliance of claim 1, wherein the cross-section has a plate area and a rib that protrudes from the plate area, and wherein a thickness of the plate area is greater than a thickness of the rib.

4. The component for the home appliance of claim 1, wherein the skin layer and the core layer are formed by injecting the first material into a mold, injecting the second material into the mold, stopping the injection of the second material, and then stopping the injection of the first material.

5. A method of manufacturing a component for a home appliance having a plate shape and a cross-section including a skin layer and a core layer disposed between the skin layer, the method comprising:
injecting a first material forming the skin layer into a mold;
injecting a second material forming the core layer into the mold, the second material being different from the first material;
stopping the injection of the second material; and
stopping the injection of the first material.

6. The method of claim 5, wherein the cross-section has a vertical area and a horizontal area, and wherein a thickness of the vertical area is greater than a thickness of the horizontal area.

7. The method of claim 5, wherein the cross-section has a plate area and a rib that protrudes from the plate area, and wherein a thickness of the plate area is greater than a thickness of the rib.

8. A component for a home appliance manufactured using on the method of claim 5.

9. A component for a home appliance made of a plate, the component having a cross-section comprising;
a skin layer made of a first material by injection-molding; and
a core layer disposed on the skin layer and made of a second material, which is different from the first material, by injection-molding, wherein the cross-section has a plate portion and a rib that protrudes from the plate portion, wherein the plate portion has a curved portion and a straight portion, wherein the straight portion has a vertical portion and a horizontal portion, wherein a thickness of the curved portion is greater than a thickness of the vertical portion, the thickness of the vertical portion is greater than a thickness of the horizontal portion, and the thickness of the horizontal portion is greater than a thickness of the rib.

10. The component for the home appliance of claim 9, wherein the skin layer and the core layer are formed by injecting the first material into a mold, injecting the second material into the mold, stopping the injection of the second material, and then stopping the injection of the first material.
